(19) United States
(12) Patent Application Publication
(10) Pub. No.: US 2025/0142194 A1
(43) Pub. Date: May 1, 2025

(54) BONDED BODY, MANUFACTURING METHOD OF BONDED BODY, IMAGING MODULE, ELECTRONIC DEVICE, AND RESIN COMPOSITION

(71) Applicant: CANON KABUSHIKI KAISHA, Tokyo (JP)

(72) Inventors: TOSHIYUKI YOSHIDA, Kanagawa (JP); HIROKI SAITO, Kanagawa (JP)

(21) Appl. No.: 18/923,896

(22) Filed: Oct. 23, 2024

(30) Foreign Application Priority Data
Nov. 1, 2023 (JP) 2023-187882

(51) Int. Cl. H04N 23/54; C08K 3/26; C08K 3/36; C08K 5/50; C09J 163/00

(52) U.S. Cl. CPC H04N 23/54; C08K 3/26; C08K 3/36; C08K 5/50; C09J 163/00; C08K 2003/265; C08K 2201/003; C09J 2463/00

(57) ABSTRACT

A bonded body according to the present disclosure, includes: a first adherend containing an epoxy resin; and a second adherend that is bonded to the first adherend via an adhesive portion containing an epoxy resin, wherein the first adherend is a molded body having a phosphorus compound on its surface.

### BACKGROUND

### Field

The present disclosure relates to a bonded body, a manufacturing method of a bonded body, an imaging module, an electronic device, and a resin composition.

### Description of the Related Art

Charge-coupled device (CCD) image sensors and complementary metal oxide semiconductor (CMOS) image sensors are used in digital cameras and video cameras. The package of the image sensor is a semiconductor module with a hollow structure. The semiconductor module having the hollow structure includes a wiring substrate on which a semiconductor element is mounted, a frame-shaped member provided at an outer edge portion of a mounting region of the semiconductor element, and a sealing plate. The semiconductor module has a structure in which the sealing plate is attached from above the wiring substrate via an adhesive to hollow seal the semiconductor element.

Japanese Patent Application Laid-Open No. 2017-188621 discloses a semiconductor mounting package that includes a printed circuit board having a base material with a mounting surface for mounting a semiconductor element and a conductive wire disposed on the base material, a resin frame surrounding the mounting surface through an adhesion-treated surface provided on the base material, and a sealing plate covering a space formed by the mounting surface of the base material and the resin frame.

### SUMMARY

According to an aspect of the present disclosure, there is provided a bonded body including: a first adherend containing an epoxy resin; and a second adherend that is bonded to the first adherend via an adhesive portion containing an epoxy resin, wherein the first adherend is a molded body having a phosphorus compound on its surface.

Further features of the present invention will become apparent from the following description of exemplary embodiments with reference to the attached drawings.

### BRIEF DESCRIPTION OF THE DRAWINGS

FIG. 1 is a top view illustrating an example of a bonded body according to a first embodiment of the present disclosure.

FIG. 2 is a cross-sectional view taken along line A-A of the bonded body illustrated in FIG. 1.

FIG. 3 is a cross-sectional view taken along line B-B of the bonded body illustrated in FIG. 1.

FIG. 4 is a diagram for explaining a digital camera as an example of an electronic device according to a second embodiment of the present disclosure.

FIG. 5 is a diagram illustrating a blending ratio of a bonding resin composition constituting a bonded body in Examples and Comparative Examples of the present disclosure.

FIG. 6 is a diagram illustrating the conditions of the surface of the molded body, the conditions of the bonding interface, and the evaluation of bonding reliability of the bonded body in Examples and Comparative Examples of the present disclosure.

### DESCRIPTION OF THE EMBODIMENTS

In a semiconductor module in which a semiconductor element is hollow-sealed, a sealed space of the semiconductor element is likely to expand when the semiconductor module is used in an environment of low atmospheric pressure due to the influence of a pressure difference from the outside air. Further, in the semiconductor module, since the thickness of the sealing plate is thinner than the thickness of the resin frame, the sealing plate is easily deformed. In recent years, the semiconductor module has been increasingly used in use environments at higher altitudes. Therefore, the volume of the sealed space further expands due to the pressure difference between the outside air pressure and the inside of the sealed space, so that the deformation of the sealing plate increases. As a result, the resin frame or the sealing plate is peeled off at the interface between the resin frame and the adhesive interposing between the resin frame and the sealing plate, and the bonding reliability of the product is decreased.

Therefore, an object of the present disclosure is to provide a bonded body having excellent bonding reliability, a method of manufacturing the bonded body, an imaging module, an electronic device, and a resin composition.

Hereinafter, embodiments of the present disclosure will be described with reference to the drawings. However, the embodiment described below is one embodiment of the invention and is not limited thereto. A common configuration will be described with reference to a plurality of drawings, and a description of a configuration denoted by a common reference numeral will be omitted as appropriate.

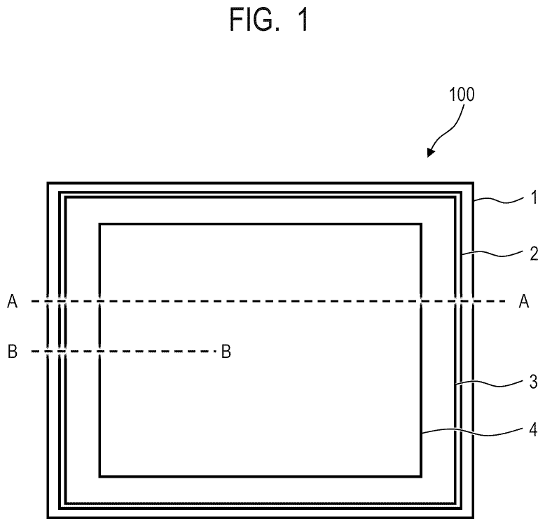

FIGS. 1 to 3 are diagrams of a schematic configuration of an imaging sensor package illustrating an example of a bonded body according to the present embodiment. In the present disclosure, a first adherend corresponds to a resin frame 2 described below. A second adherend corresponds to a wiring substrate 1 or a sealing plate 3.

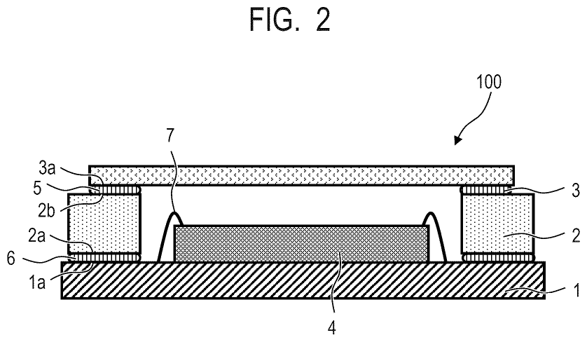

FIG. 1 is a top view illustrating an example of the bonded body according to the present embodiment. FIG. 2 is a cross-sectional view taken along line A-A of the bonded body illustrated in FIG. 1. The bonded body illustrated in FIG. 2 is a state at room temperature (25° C.).

As illustrated in FIGS. 1 and 2, the bonded body 100 includes the wiring substrate 1, the resin frame 2, and the sealing plate 3. A surface 1a of the wiring substrate 1 is a mounting surface on which a semiconductor element 4 is disposed. The frame-shaped resin frame 2 is disposed on the surface 1a so as to surround the semiconductor element 4. Regarding the wiring substrate 1 and the resin frame 2, the mounting surface 1a on the wiring substrate 1 and one surface 2a of the resin frame 2 are bonded to each other via an adhesive portion 6 (not illustrated in FIG. 1). Regarding the resin frame 2 and the sealing plate 3, another surface 2b of the resin frame 2 and one surface 3a of the sealing plate 3 are bonded to each other via an adhesive portion 5 (not illustrated in FIG. 1). In addition, the semiconductor element 4 is provided in a central portion of the wiring substrate 1. The semiconductor element 4 is electrically connected to the wiring substrate 1 via a metal wire 7.

Hereinafter, each member will be explained.

### (Wiring Substrate)

As the wiring substrate 1, for example, a printed circuit board, a glass composite substrate, a glass epoxy substrate, or a ceramic substrate can be used. In order to mount the semiconductor element 4 on the wiring substrate 1, the wiring substrate 1 is provided with electrodes (not illustrated) patterned in advance on the mounting surface 1a. Further, the electrodes may be provided not only on the mounting surface 1a of the wiring substrate 1 but also on the back surface (not illustrated). The thickness of the wiring substrate 1 is not necessarily limited. The thickness is, for example, 0.1 mm to 3 mm.

### (Resin Frame)

The resin frame 2 is a frame-shaped member that is bonded by the bonding portion 6 on the same surface as the mounting surface 1a of the semiconductor element 4 of the wiring substrate 1 to surround the mounting region of the semiconductor element 4 on the wiring substrate 1. The resin frame 2 preferably has a rectangular shape. The thickness of the resin frame 2 is preferably thicker than the thickness of the semiconductor element 4 to accommodate the semiconductor element 4. The thickness of the resin frame 2 is preferably 0.5 mm to 3.0 mm.

Further, as illustrated in FIG. 2, the resin frame 2 is disposed only on the mounting surface 1a on the wiring substrate 1, but the present disclosure is not limited to such an embodiment. For example, the resin frame 2 may further cover the side surface of the wiring substrate 1. The resin frame 2 may further cover the side surface of the sealing plate 3.

### (Adhesive)

Each of the adhesive portion 5 and the adhesive portion 6 is a cured product of an adhesive. As the adhesive of the adhesive portion 5 and the adhesive of the adhesive portion 6, in view of moisture resistance or bonding strength, a well-known commercially available adhesive containing, as a main component, an epoxy resin that forms a dense cured structure can be used. A curing material, a filler, or the like may be appropriately blended in the adhesive. The curing method is not limited and can be appropriately selected according to the purpose such as dry curing, two-component mixture curing, and energy curing (thermal curing and photocuring).

For example, since the adhesive of the adhesive portion 6 is interposes between the wiring substrate 1 and the resin frame 2, a thermosetting adhesive is preferable used. In addition, since the adhesive of the adhesive portion 5 interposes between the resin frame 2 and the sealing plate 3 and seals the space surrounded by the mounting surface 1a of the semiconductor element 4 of the wiring substrate 1 and the resin frame 2, the space may expand in an uncured state at the time of heating when the thermosetting adhesive is used. Therefore, a photocurable adhesive that does not require heating can be preferred as the adhesive of the adhesive portion 5. After the curing has sufficiently progressed, heating may be supplementarily performed for thermal curing. Thus, the adhesive of the adhesive portion 5 and the adhesive of the adhesive portion 6 are preferably energy-curable resin compositions that are cured by heat or light.

The thicknesses of the adhesive portion 5 and the adhesive portion 6 are preferably 5 μm or more and 300 μm or less, and more preferably 10 μm or more and 100 μm or less. When the thicknesses of the adhesive portion 5 and the adhesive portion 6 are 5 μm or more, a sufficient adhesive effect can be obtained for both adherents (the wiring substrate 1 and the resin frame 2, the resin frame 2 and the sealing plate 3). When the thicknesses of the bonding portion 5 and the bonding portion 6 are 300 μm or less, distortion of the bonded body due to curing shrinkage can be suppressed to a minimum.

### (Sealing Plate)

The sealing plate 3 is a plate-like member that seals a space surrounded by the mounting surface 1a of the semiconductor element 4 of the wiring substrate 1 and the resin frame 2. When the sealing plate is used in an imaging sensor package as an example of the bonded body of the present disclosure, the sealing plate 3 is preferably a light transmissive member (light transmissive lid member) that is transparent to light such as visible light. Examples of the material used for the sealing body include plastic, glass (such as borosilicate glass, quartz glass, alkali-free glass, and heat-resistant glass), and quartz. An antireflection coating or an infrared cut coating may be provided on the surface of the sealing plate 3. When a photocurable adhesive is used as the adhesive of the adhesive portion 5, the sealing plate 3 preferably has sufficient light transmittance with respect to the wavelength of light for curing the photocurable adhesive.

The bonded body 100 is required to be flat after the sealing plate 3 is installed. Therefore, the thickness of the sealing plate 3 is preferably 0.1 mm or more and 2 mm or less, and more preferably 0.5 mm or more and 1.5 mm or less.

### (Semiconductor Element)

The semiconductor element 4 is, for example, a semiconductor element such as a CMOS or a CCD. As in the example illustrated in FIG. 1, the semiconductor element 4 is mounted on the mounting surface 1a of the wiring substrate 1 and is electrically connected to the electrodes of the wiring substrate 1 using the metal wire 7. The semiconductor element 4 may be mounted on the wiring substrate 1 by flip-chip bonding.

Hereinafter, a material and a manufacturing method of the resin frame 2 in the imaging sensor package as an example of the bonded body according to the embodiment of the present disclosure will be described in detail.

### (Constituent Material of Resin Frame)

The resin frame 2 is formed by a cured product of a bonding resin composition with thermosetting properties (This is also referred to as a “curable resin composition”) composed of a predetermined material (Epoxy resin, curing material, organic phosphorus compound, filler and additive).

### Epoxy Resin

Examples of the epoxy resin contained in the bonding resin composition include a triphenylmethane-type epoxy resin, a dicyclopentadiene-type epoxy resin, a naphthol-cresol novolac-type epoxy resin, a polyfunctional epoxy resin, a bisphenol A-type epoxy resin, a bisphenol F-type epoxy resin, a cyclic aliphatic-type epoxy resin, a long chain aliphatic-type epoxy resin, a glycidyl ester-type epoxy resin, and a glycidyl amine-type epoxy resin. Among them, the polyfunctional epoxy resin is preferable because the polyfunctional epoxy resin has small equivalent amounts and the polyfunctional epoxy resin has excellent heat resistance, chemical resistance, and electrical properties. The content of the epoxy resin in the bonding resin composition is, for example, 3 parts by mass or more and 25 parts by mass or less.

### Curing Material

Examples of the curing material contained in the bonding resin composition include materials that cause a curing reaction to an epoxy resin, such as an amine-type curing material (an aliphatic amine, an aromatic amine, or the like), an imidazole-type curing material, an acid anhydride curing material, and a novolac-type phenol resin curing material. Among them, the novolac-type phenol resin curing material is preferable because the cured product of the novolac-type phenol resin curing material has a high crosslinking density and excellent heat resistance, moisture resistance, chemical resistance, and the like. The blending amount of the curing material with respect to the epoxy resin is determined by the blending amount of the epoxy resin and the equivalent amounts of the reactive functional groups of the epoxy resin and the curing material.

### Organic Phosphorus Compound

The organic phosphorus compound contained in the bonding resin composition acts as a curing accelerator for the epoxy resin described above. The curing accelerator is a catalyst for accelerating a polymerization reaction by radically ring-opening an epoxy group of an epoxy resin or by radicalizing a reactive functional group of a curing material. Examples of the organic phosphorus compound include triphenylphosphine, tri-o-tolylphosphine, tri-p-tolylphosphine, diphenylcyclohexylphosphine, tricyclohexylphosphine, tetra-n-butylphosphonium laurate, 1,2-bis(diphenylphosphino)acetylene, and the like. Among these, tri-p-tolylphosphine, which has excellent latentness, is preferable.

When the total amount of the epoxy resin and the curing material is defined as 100 parts by mass, an amount of the organic phosphorus compound is preferably 0.1 parts by mass or more and 5 parts by mass or less, and more preferably 0.5 parts by mass or more and 3 parts by mass or less, When the total amount of the epoxy resin and the curing material is defined as 100 parts by mass and the amount of a release agent is 0.5 parts by mass or more, it is possible to cure quickly. When the amount of the release agent is 5 parts by mass or less, the release agent is stabilized without being cured at the time of heating and melting before molding. Therefore, productivity can be improved.

### Filler

The filler contained in the bonding resin composition is used to adjust the linear expansion coefficient and the elastic modulus. If the linear expansion coefficient and the elastic modulus are significantly different from those of the wiring substrate 1 and the sealing plate 3, there is a fear that due to reflow heating at the time of bonding or at the time of mounting the semiconductor element 4 and the component, strain at the bonding interface becomes large with respect to thermal deformation of the wiring substrate 1 and the sealing plate 3, and bonding failure occurs.

The filler is preferably an inorganic filler, and examples of the filler include silica particles such as spherical silica and crystalline silica, aluminum oxide, titanium oxide, zirconium oxide, magnesium oxide, calcium silicate, calcium carbonate, potassium titanate, silicon carbide, silicon nitride, boron nitride, and aluminum nitride. One kind of inorganic filler may be used alone, or two or more kinds of inorganic fillers may be used in combination. Among these, silica particles having a small linear expansion coefficient are preferable from the viewpoint of adjusting the linear expansion coefficient of the bonding resin composition, and calcium carbonate particles are preferable from the viewpoint of adjusting the elastic modulus of the bonding resin composition.

The ratio of the silica particles in the bonding resin composition when adjusting the linear expansion coefficient is preferably in the range of 60 parts by mass or more and 95 parts by mass or less, and more preferably in the range of 65 parts by mass or more and 90 parts by mass or less, in order to preferably set the difference in the linear expansion coefficient between the wiring substrate 1 and the sealing plate 3 to 10 ppm/K or less.

In order to highly fill the silica particles, it is preferable to use a mixture of two or more kinds of silica particles having different center particle diameters. More specifically, the center particle diameter of the silica particles having a large particle diameter is preferably 10 μm or more, and the center particle diameter of the silica particles having a small particle diameter is preferably 1 μm or less. Further, it is more preferable that the center particle diameter of the silica particles having a large particle diameter is 20 μm or more, and the center particle diameter of the silica particles having a small particle diameter is 0.5 μm or less. The content of the silica particles having a large particle diameter is preferably 1 to 20 times that of the silica particles having a small particle diameter.

Further, the ratio of the center particle diameter of the silica particle having a small particle diameter to the center particle diameter of the silica particle having a large particle diameter is preferably in the range of 0.001 or more and 0.5 or less, and more preferably in the range of 0.01 or more and 0.2 or less.

The proportion of calcium carbonate in the joining resin composition when adjusting the elastic modulus is preferably in the range of 1 part by mass or more and 20 parts by mass or less, and more preferably in the range of 5 parts by mass or more and 15 parts by mass or less, so as not to break when the bonded body is thermally deformed.

### Additives

The bonding resin composition may contain various additives such as a coupling agent, a release agent, a flame retardant, and a colorant exemplified below in addition to the above components. The bonding resin composition may contain additives other than the following additives. The bonding resin composition may contain various additives well-known in the art, if necessary.

The coupling agent can be used from the viewpoint of enhancing affinity and adhesion between the epoxy resin and the inorganic filler. Examples of the coupling agent include silane coupling agents having a glycidyl group, a mercapto group, an amino group, an alkyl group, a urea group, and a vinyl group at the terminal. Among these, a silane coupling agent having a glycidyl group at its terminal is preferably used because the silane coupling agent has a high affinity for an epoxy resin and can exhibit high adhesion to an inorganic filler.

When the amount of the silane coupling agent is too small, the surface modification effect on the inorganic filler is not sufficiently exhibited. On the other hand, when the amount of the silane coupling agent is too large, the excess silane coupling agent deteriorates the performance, such as the elastic modulus of the bonding resin composition. Therefore, the amount of the silane coupling agent is preferably in the range of 0.1 parts by mass or more and 5 parts by mass or less, and more preferably in the range of 0.2 parts by mass or more and 2 parts by mass or less with respect to 100 parts by mass of the silica particles.

The release agent is used to smoothly release the resin composition from the molding machine in molding the resin composition. The release agent is not limited, and conventionally known release agents can be used. Specific examples thereof include higher fatty acids such as carnauba wax, montanic acid, and stearic acid; higher fatty acid metal salts such as metal soap; ester waxes; and polyolefin waxes such as oxidized polyethylene and non-oxidized polyethylene. The release agents may be used alone or in combination of two or more.

The amount of the release agent is preferably in the range of 0.1 parts by mass or more and 10 parts by mass or less, and more preferably in the range of 0.5 parts by mass or more and 5 parts by mass or less, when the total amount of the epoxy resin and the curing material is defined as 100 parts by mass. When the total amount of the epoxy resin and the curing material is defined as 100 parts by mass and the amount of the release agent is 0.5 parts by mass or more, sufficient releasability is obtained. When the amount of the release agent is 10 parts by mass or less, better bonding properties can be obtained.

The flame retardant is used to secure flame retardancy of the resin composition. The flame retardant is not limited, and conventionally known flame retardants can be used. Examples of the flame retardant include organic or inorganic compounds containing a bromine atom, an antimony atom, a nitrogen atom or a phosphorus atom, and metal hydroxides. The flame retardants may be used alone or in combination of two or more kinds thereof.

The colorant is used to adjust the color of the resin composition. The colorant is not limited, and conventionally known colorants can be used. Examples of the colorant include known colorants such as carbon black, organic dyes, organic pigments, titanium oxide, red lead, and red iron oxide. The content of the colorant can be appropriately selected according to the purpose and the like. The colorants may be used alone or in combination of two or more kinds thereof. In an imaging sensor package, which is an example of the bonded body according to the present disclosure, carbon black is preferable in order to reduce gloss and prevent diffuse reflection of incident light. The content of the carbon black is, for example, 0.01% by mass or more and 1% by mass or less.

### (Method for Manufacturing a Molded Body)

The molded body (resin frame 2) of the present disclosure is manufactured, for example, as follows. The resin frame 2 is formed of the bonding resin composition. First, materials (epoxy resin, cured resin, additive, filler) other than the organic phosphorus compound among the predetermined materials are mixed in a predetermined amount, and a hot-melt kneading is performed to obtain a kneaded resin composition. For the hot-melt kneading, a kneader roll or a twin-screw kneader previously heated to 70 to 120° C. is used. The organic phosphorus compound weighed in a predetermined amount is added to the kneaded resin composition, and the mixture is miniaturized using a mixer, a pulverizer, or the like to obtain a bonding resin composition.

If the organic phosphorus compound is added at the start of the hot-melt kneading, a thermosetting reaction is likely to occur during the hot-melt kneading. If the thermosetting reaction of the material is started during the hot-melt kneading, the viscosity of the resin composition becomes high, which makes it difficult to perform molding in the next step. In addition, the organic phosphorus compound undergoes shearing during the hot-melt kneading to be finely dispersed and covered in the resin. Therefore, the organic phosphorus compound cannot be exposed on the surface of the molded body at the time of molding, and the adhesion to the adhesive cannot be improved.

Next, the bonding resin composition is heated and melted again at 70 to 100° C. and poured into a mold previously heated to 160 to 190° C. A molded body (resin frame 2) is obtained by thermally curing the bonding resin composition in the mold for a certain period. Examples of the molding method include injection molding, compression molding, and transfer molding. Among these methods, injection molding capable of being continuously produced is preferable. When sufficient curing time cannot be secured at the stage of molding, it is preferable to conduct a main curing treatment after molding.

### (Regarding Molded Body)

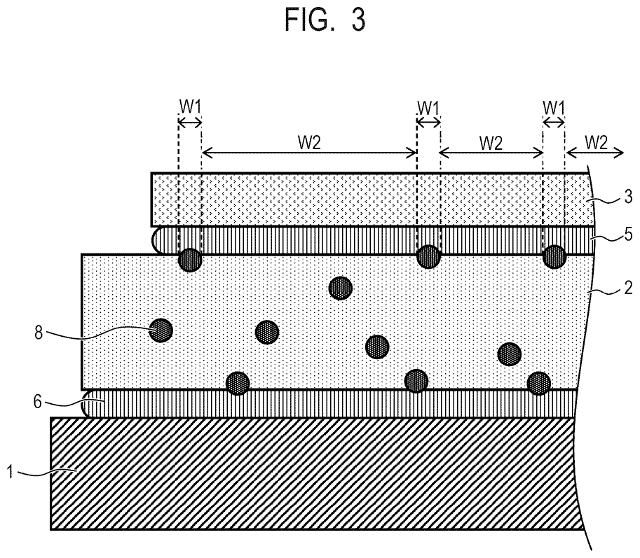

FIG. 3 is a cross-sectional view taken along line B-B of the bonded body illustrated in FIG. 1. The bonded body illustrated in FIG. 3 is in a state at room temperature. As illustrated in FIG. 3, an organic phosphorus compound aggregate 8 is dispersed in the resin frame 2.

As in the past, when the hot-melt kneading is performed to the organic phosphorus compound aggregate 8 together with other materials, the organic phosphorus compound aggregate 8 is crushed and covered with the resin. Therefore, when molding is performed using such a material, a skin layer of the resin is formed on the surface of the molded body, so that the organic phosphorus compound does not emerge from the surface of the molded body.

On the other hand, in the present disclosure, the organic phosphorus compound is added in a process of miniaturizing the kneaded resin composition. Therefore, in the bonding resin composition, the organic phosphorus compound remains as the organic phosphorus compound aggregate 8 and is mixed with the kneaded resin composition.

Therefore, also in the molding process, the kneaded resin composition, and the organic phosphorus compound aggregate 8 are molded in a mixed state. Since the organic phosphorus compound aggregate 8 is not crushed in the molding process, the organic phosphorus compound aggregate 8 still exists in the molded body. Since the inside of the organic phosphorus compound aggregate 8 is not covered with the resin, the organic phosphorus compound aggregate 8 also exists in the vicinity of the surface of the molded body.

The organic phosphorus compound aggregate 8 exists on the surface of the molded body and exists at the interface with the bonding portion formed at the time of bonding to the wiring substrate 1 or the sealing plate 3.

The existence or non-existence of the organic phosphorus compound in each of the surface of the resin frame 2, the interface region between the resin frame 2 and the adhesive portion 5, and the interface region between the resin frame 2 and the adhesive portion 6 can be determined by an electron microscope (SEM) and an energy dispersive X-ray spectroscopy (EDX) with the electron microscope.

The elemental phosphorus of the organic phosphorus compound can be quantified using an EDX apparatus connected to an electron microscope (SEM) and EDX software. For example, the electron microscope (SEM) is set at an acceleration voltage of 10 kV, a working distance of 8 mm, and a magnification of 500 times. The phosphorus element of the organic phosphorus compound can be quantified by collecting EDX spectra using an EDX apparatus, automatically performing component quantification using EDX software, and subtracting background for peaks of Kα rays of 1.9 keV to 2.1 keV identified as phosphorus elements.

In addition, the distribution of the phosphorus element in the observation field of view can be evaluated by performing the measurement in the mapping mode. When the region near the interface between the resin frame 2 and the adhesive portion 5 or the region near the interface between the resin frame 2 and the adhesive portion 6 is subjected to cross-sectional processing and observed by EDX analysis, and it is preferable that the phosphorus element is not uniformly detected along the interface and a region where the detected amount of the phosphorus element is large or small exists. When the phosphorus element is uniformly detected, that is, when the organic phosphorus compound aggregate 8 is uniformly present at the interface, the bonding region between the resin frame 2 and the bonding portion 5 and the bonding region between the resin frame 2 and the bonding portion 6 are reduced, and the adhesion between the resin frame 2 and each bonding portion is lowered, which may impair the bonding reliability.

Further, as illustrated in FIG. 3, it is preferable that the width W1 in the interface direction of the region in which a large amount of phosphorus element is detected at the interface between the resin frame 2 and the adhesive portion 5 is shorter than the width W2 in the interface direction of the region in which a small amount of phosphorus element is detected. If the width W1 becomes longer than the width W2, that is, if the amount of the organic phosphorus compound aggregate 8 on the surface of the molded body becomes large, the adhesion between the resin frame 2 and the adhesive portion 5 decreases, and the bonding reliability may be decreased.

Since the organic phosphorus compound aggregate 8 that exists in the interface between the resin frame 2 and the adhesive portion 5 also exhibits a curing promoting effect on the epoxy resin which is the main component of the adhesive, the adhesion between the resin frame 2 and the adhesive portion 5 is improved, and the reliability of the bonded body is improved. Since the organic phosphorus compound aggregate 8 also exists in the interface between the resin frame 2 and the adhesive portion 6, the adhesion between the resin frame 2 and the adhesive portion 6 is improved, and the reliability of the bonded body is improved.

In detail, the organic phosphorus compound that exists in the interface initiates an initiation reaction with respect to the epoxy resin as a main component during the curing process of the adhesive, thereby initiating a polymerization reaction. On the other hand, it is presumed that the organic phosphorus compound in the interface also causes an initiation reaction to the unreacted epoxy group of the resin frame 2 and forms a chemical bond between the resin frame 2 and each adhesive.

According to the present embodiment, since the adhesion between the resin frame 2 and the adhesive portion 5 and the adhesion between the resin frame 2 and the adhesive portion 6 are improved, a bonded body having excellent bonding reliability can be provided.

### Second Embodiment

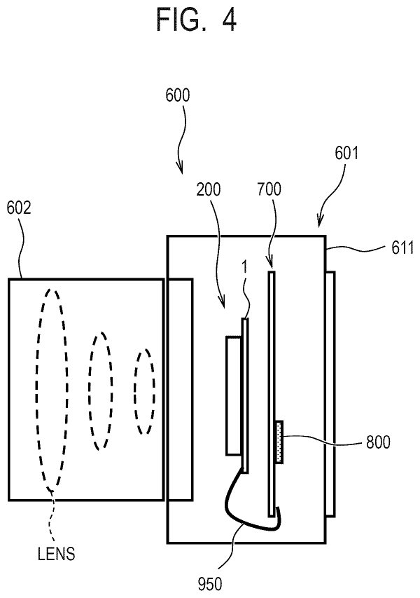

FIG. 4 is a diagram for explaining a digital camera 600 that is an example of the electronic device according to a second embodiment.

In the present embodiment, the digital camera 600 is an interchangeable-lens digital camera and includes a camera body 601. A lens unit 602 including a lens is detachable from the camera body 601. The camera body 601 includes a housing 611, and an imaging module 200 and a printed circuit board 700 which are disposed in the housing 611.

The imaging module 200 and the printed circuit board 700 are electrically connected by a cable 950. An imaging element (not illustrated), which is a semiconductor element, is mounted on the imaging module 200. The imaging element is, for example, a Complementary Metal Oxide Semiconductor (CMOS) image sensor or a Charge Coupled Device (CCD) image sensor. The imaging element has a function of converting light incident through the lens unit 602 into an electrical signal. The imaging element is bonded to a wiring substrate 1 which is an imaging sensor substrate. As in the first embodiment, the wiring substrate 1 is bonded to a resin frame (not illustrated) through an adhesive containing epoxy resin. Regarding the wiring substrate 1 and the resin frame, a mounting surface of the wiring substrate 1 on which the imaging element is mounted, and one surface of the resin frame is bonded via an adhesive (not illustrated). Regarding the resin frame and the sealing plate (not illustrated), the other surface of the resin frame and one surface of the sealing plate are bonded via an adhesive (not illustrated). Thus, the imaging element is hollow sealed by the wiring substrate 1, the resin frame, and the sealing plate.

An image processing apparatus 800 is mounted on the printed circuit board 700. The image processing apparatus 800 is, for example, a digital signal processor. The image processing apparatus 800 has a function of acquiring an electrical signal from the imaging element, correcting the acquired electrical signal, and generating image data.

According to the present embodiment, it is possible to improve the bonding reliability between the components constituting the imaging module 200 of the digital camera 600.

### EXAMPLE

Hereinafter, the present disclosure will be described in more detail with reference to Examples, but the present disclosure is not limited to the following Examples. Example 1, Example 2, and Comparative Example 1 will be described with reference to the drawings with respect to an imaging sensor package illustrating an example of a bonded body of the present disclosure. In Example 1, Example 2, and Comparative Example 1, all the portions other than the resin frame 2 are common. However, the present disclosure is not limited by Examples 1 and 2 below. In Example 1, Example 2, and Comparative Example 1, the bonded body 100 according to the first embodiment illustrated in FIG. 1 was prepared. A longitudinal direction of the bonded body 100 is referred to as an X direction, and a lateral direction is referred to as a Y direction.

### Example 1

In the bonded body 100, a glass epoxy substrate, which was a plate-shaped rigid printed wiring substrate, was prepared as the wiring substrate 1. Further, as the sealing plate 3, a plate material made of quartz glass with countermeasures against α-rays was prepared. The glass epoxy substrate as the wiring substrate 1 had a thickness of 0.8 mm, an outer diameter of 54 mm in the X direction, and an outer diameter of 43 mm in the Y direction. The sealing plate 3 had a thickness of 0.7 mm, a dimension in the X direction of 53 mm, and a dimension in the Y direction of 42 mm.

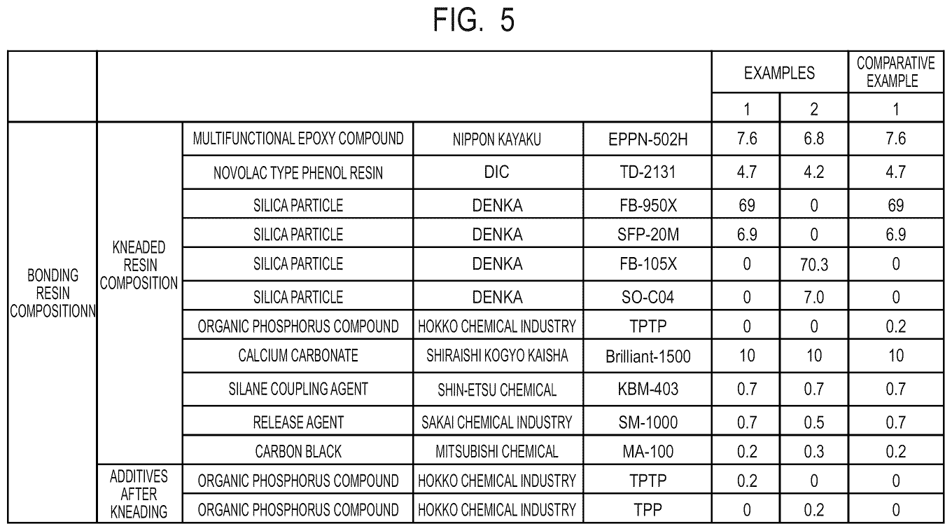

The resin frame 2 was prepared according to the following procedure. First, an epoxy resin, silica particles, a curing material, calcium carbonate, a silane coupling agent, magnesium stearate, and carbon black were mixed at room temperature. FIG. 5 is a diagram illustrating product information and a blending ratio of a bonding resin composition constituting a bonded body in Examples and Comparative Example of the present disclosure. As illustrated in FIG. 5, the bonding resin composition before the hot-melt kneading contained the following epoxy resin or the like at a predetermined blending ratio.

Epoxy resin: Multifunctional epoxy resin manufactured by Nippon Kayaku Co., Ltd., trade name/EPPN-502H, 7.6% by mass.

Curing Material: novolak type phenol resin manufactured by DIC Corporation, trade name/TD-2131, 4.7% by mass.

Silica Particles: manufactured by Denka Co., Ltd., Average particle size of 24 μm, trade name/FB-950, 69% by mass.

Silica Particles: manufactured by Denka Co., Ltd., Average particle size 0.4 μm, trade name/SFP-20M, 6.9% by mass.

Calcium Carbonate: manufactured by Shiroishi Kogyo Kaisha, Ltd., trade name/Brilliant-1500, 10% by mass.

Silane coupling agent: manufactured by Shin-Etsu Chemical Co., Ltd., trade name KBM-403, 0.7% by mass.

Magnesium Stearate: manufactured by Sakai Chemical Co., Ltd., trade name/SM-1000, 0.7% by mass.

Carbon black: manufactured by Mitsubishi Chemical Corporation, trade name/MA-100, 0.2% by mass.

Next, the mixture was heated and kneaded at 120° C. in a continuous twin-screw kneader (trade name: TEX-44α, manufactured by JSW) to obtain a kneaded resin composition. After cooling, the organic phosphorus compound: tri-p-tolylphosphine (manufactured by Hokko Chemical Kogyo Co., Ltd., trade name: TPTP) was added to the kneaded resin composition so as to be 0.2% by mass, and the mixture was pulverized and mixed with a mixer (manufactured by Kawata Mfg. Co., Ltd., trade name: SMV-100) to obtain a bonding resin composition.

Next, the bonding resin composition obtained in the above process was molded using an injection molding machine for thermosetting resin (manufactured by Shibaura Machine Co., Ltd., trade name: RC75SXR) and a mold having the shape of the resin frame 2 to obtain a molded body. The molding conditions were set to a cylinder temperature of 80° C., a mold temperature of 180° C., and a curing time of 50 seconds. After molding, heat treatment was performed at 180° C. for eight hours to obtain a resin frame 2.

Next, an adhesive, which is a precursor of the adhesive portion 6, was applied onto the wiring substrate 1 by a dispenser. As the adhesive, a thermosetting adhesive (manufactured by 3M Co., Ltd., trade name: EW2050) was used. The adhesive was applied onto the wiring substrate 1 in an amount, such that sealing was possible after bonding and the thickness of the adhesive after application was 50 μm or more and 100 μm or less. Next, the resin frame 2 was placed on the adhesive, and a weight was applied to the resin frame 2 so as to have a thickness of 10 μm or more and 50 μm or less. Then, the adhesive was cured by heating at 120° C. or more and 150° C. or less.

Next, an adhesive, which was a precursor of the bonding portion 5, was applied to the bonding surface 2b of the resin frame 2 by a dispenser. As the adhesive, an ultraviolet ray and a thermosetting adhesive (Kyoritsu Chemical & Co., Ltd., trade name: World Lock 5210) were used. The adhesive was applied to the surface of the bonding surface 2b on the resin frame 2 by a dispenser in such an amount that the semiconductor element 4 could be hermetically sealed by the wiring substrate 1, the resin frame 2, and the sealing plate 3 after bonding, and that the thickness of the adhesive after application was 30 μm or more and 50 μm or less. Further, the bonding surface 3a of the sealing plate 3 and the adhesive were overlapped with each other, and the bonding surface 3a of the sealing plate 3 and the adhesive portion 5 were bonded by curing the adhesive using an LED light source having a wavelength of 365 nm. Then, after bonding with ultraviolet rays, the bonded body was obtained by heating at 80° C. or more and 100° C. or less.

### Example 2 and Comparative Example 1

In Example 2 and Comparative Example 1, a bonded body was obtained in the same manner as in Example 1 by the blending and processes illustrated in FIG. 5. In Example 2, the silica particles in Example 1 were changed to the following two types of silica particles.

Silica Particles after Change
1. Manufactured by Denka Co., Ltd., Average particle size of 10 μm, trade name: FB-105X, 70.3% by mass
2. Manufactured by Denka Co., Ltd., Average particle size of 1 μm, trade name: SO-C04, 7.0% by mass

The organic phosphorus compound was changed to other organic phosphorus compound (trade name: triphenylphosphine (TPP), manufactured by Hokko Chemical Kogyo Co., Ltd., 0.2% by mass). In Comparative Example 1, the organic phosphorus compound of Example 1 was included in the kneaded resin composition in 0.2% by mass.

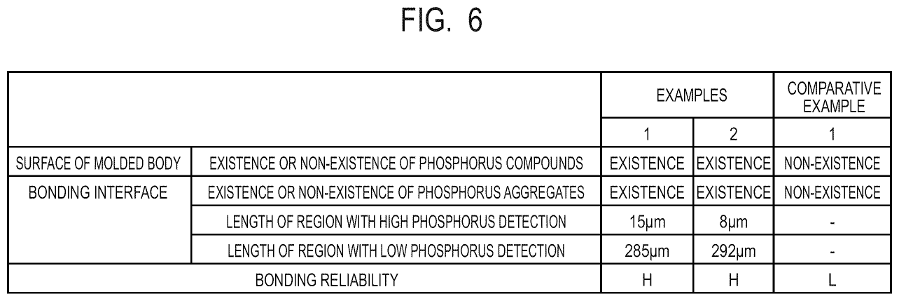

FIG. 6 is a diagram illustrating the conditions of the surface of the molded body, the conditions of the bonding interface, and the evaluation of bonding reliability of the bonded body in Examples and Comparative Examples of the present disclosure. Here, the existence or non-existence of a phosphorus compound is illustrated as a condition of the surface of the molded body. As the conditions of the bonding interface, the existence or non-existence of phosphorus aggregates, the length of a region where the amount of detected phosphorus is large, and the length of a region where the amount of detected phosphorus is small are indicated.

### (Bonding Reliability Evaluation)

As illustrated in FIG. 6, the bonded bodies obtained in the above Examples and Comparative Example were evaluated for bonding reliability by the following method. The bonding reliability was evaluated based on the pressure change method chamber method of JIS Z2330. The bonded body was placed in a chamber and the chamber was evacuated to 200 hPa. When the exhaust gas was stopped and allowed to stand for one hour, the fluctuation of the pressure gauge in the chamber was 5 hPa or less per minute, and equilibrium was obtained, it was evaluated that the adhesion of the bonded body was high, and the bonding reliability was high (“H”). In addition, when the pressure gauge in the chamber was changed by five hPa or more per minute, it was considered that there was gas leakage from the inside of the bonded body, that is, bonding failure occurred, and it was evaluated that the bonding reliability was low (“L”).

As is clear from FIG. 6, the bonded bodies of Example 1 and Example 2 are superior in bonding reliability to the bonded body of Comparative Example.

### Modified Embodiments

The present disclosure is not limited to the above-described embodiments, and various modifications are possible. For example, an example in which a part of the configuration of any of the embodiments is added to another embodiment or an example in which a part of the configuration of the embodiments is replaced with another embodiment is also an embodiment of the present disclosure.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

This application claims the benefit of Japanese Patent Application No. 2023-187882, filed on Nov. 1, 2023, which is hereby incorporated by reference herein in its entirety.

What is claimed is:

1. A bonded body comprising:
a first adherend containing an epoxy resin; and
a second adherend that is bonded to the first adherend via an adhesive portion including an epoxy resin,
wherein the first adherend is a molded body having a phosphorus compound on its surface.

2. The bonded body according to claim 1,
wherein the phosphorus compound exists between the first adherend and the adhesive portion in at least a part of an interface between the first adherend and the adhesive portion.

3. The bonded body according to claim 1,
wherein in cross-sectional observation of the bonded body by an electron microscope and analysis of a region of the cross-sectional observation by energy dispersive X-ray spectroscopy, a length in an interface direction of a region where a large amount of phosphorus element is detected at an interface between the first adherend and the adhesive portion is shorter than a length in the interface direction of a region where a small amount of the phosphorus element is detected at the interface.

4. The bonded body according to claim 1,
wherein the first adherend is a cured product of a resin composition including at least an epoxy resin, a phenol resin curing material, and the phosphorus compound.

5. The bonded body according to claim 1,
wherein the phosphorus compound is an organic phosphorus compound.

6. The bonded body according to claim 5,
wherein the organic phosphorus compound is any of triphenylphosphine, tri-o-tolylphosphine, tri-p-tolylphosphine, diphenylcyclohexylphosphine, tricyclohexylphosphine, tetra-n-butylphosphonium laurate, and 1,2-bis(diphenylphosphino)acetylene.

7. The bonded body according to claim 1,
wherein the phosphorus compound is tri-p-tolylphosphine.

8. The bonded body according to claim 1,
wherein the first adherend contains at least an inorganic filler.

9. The bonded body according to claim 8,
wherein the inorganic filler is silica particles.

10. The bonded body according to claim 9,
wherein the silica particles include a first silica particles having a center particle diameter of 10 μm or more and a second silica particles having a center particle diameter of 1 μm or less.

11. The bonded body according to claim 8,
wherein the inorganic filler is calcium carbonate.

12. The bonded body according to claim 1,
wherein the second adherend is a light transmissive member.

13. The bonded body according to claim 1,
wherein the adhesive portion contains a cured product of an energy-curable resin composition.

14. The bonded body according to claim 1,
wherein the bonded body is an imaging sensor package including an imaging sensor substrate, a light transmissive lid member, a frame-shaped member, and the adhesive portion, and
wherein, one of the imaging sensor substrate and the framed member is the first adherend, and the other is the second adherend.

15. An imaging module comprising:
a wiring substrate;
an imaging element mounted on the wiring substrate; and
a frame-shaped member that is bonded to the wiring substrate so as to surround the imaging element,
wherein the frame-shaped member contains an epoxy resin and is a molded body having a phosphorus compound on its surface, and
wherein the wiring substrate is bonded to the frame-shaped member via an adhesive portion including an epoxy resin.

16. An electronic device comprising:
a housing; and
the imaging module according to claim 15, wherein the imaging module is provided inside the housing.

17. A resin composition comprising: at least an epoxy resin, a curing material, and an organic phosphorus compound,
wherein when the total amount of the epoxy resin and the curing material is 100 parts by mass, the organic phosphorus compound is contained in a ratio of 0.1 parts by mass or more and 5 parts by mass or less.

18. The resin composition according to claim 17, wherein the resin composition contains silica particles and calcium carbonate,
wherein the epoxy resin is contained in the range of 3 parts by mass or more and 25 parts by mass or less,
wherein the silica particles are contained in the range of 60 parts by mass or more and 95 parts by mass or less,
wherein the calcium carbonate is contained in the range of 1 part by mass or more and 20 parts by mass or less, and
wherein the organic phosphorus compound is tri-p-tolylphosphine, when the total amount of the epoxy resin and the curing material is defined as 100 parts by mass, the epoxy resin and the curing material are contained in a ratio of 0.1 parts by mass or more and 5 parts by mass or less.
